(19) United States
(12) Patent Application Publication
(10) Pub. No.: US 2013/0107675 A1
(43) Pub. Date: May 2, 2013

(54) HOURGLASS TIMER

(71) Applicant: Daniel W. Forbes, Boynton Beach, FL (US)

(72) Inventor: Daniel W. Forbes, Boynton Beach, FL (US)

(21) Appl. No.: 13/666,641

(22) Filed: Nov. 1, 2012

Related U.S. Application Data
(60) Provisional application No. 61/554,345, filed on Nov. 1, 2011.

(51) Int. Cl. G04F 1/06

(52) U.S. Cl. 368/93

(57) ABSTRACT

The present invention relates generally to hourglass timer devices. More specifically, the present invention relates to novelty hourglass timer devices featuring continuous replenishment and variable timing capabilities.

The present application claims priority to U.S. Provisional Patent Application Ser. No. 61/554,345, filed Nov. 1, 2011, the disclosure of which is herein incorporated by reference in its entirety.

### FIELD OF THE INVENTION

The present invention relates generally to hourglass timer devices. More specifically, the present invention relates to novelty hourglass timer devices featuring continuous replenishment and variable timing capabilities.

### BACKGROUND OF THE INVENTION

Conventional hourglass-type timer devices are well known in the art. Such devices typically consist of an upper and lower chamber connected by a narrowed passage, and filled with a granular filler material such as sand. The filler material flows via gravity from the upper chamber to the lower chamber. After all of the filler material from the upper chamber has been depleted, a conventional hourglass device must be inverted in order to replenish the filler material in the upper chamber. Conventional hourglass timers can be imprecise and inconsistent when used as a timer.

### SUMMARY OF THE INVENTION

The present invention relates generally to hourglass timer devices. More specifically, the present invention relates to novelty hourglass timer devices featuring continuous replenishment and variable timing capabilities.

In some embodiments, provided herein is a hourglass timer device comprising: a hollow upper chamber capable of holding a filler material and comprising a bottom opening; a hollow lower chamber capable of holding a filler material and comprising a top opening; a depletion passage interconnecting the bottom opening of the upper chamber and the top opening of the lower chamber; a filler material that is capable of flowing by the force of gravity from the upper chamber to the lower chamber through the depletion passage interconnecting the two chambers; a replenishment passage interconnecting the upper and lower chambers; and a component for moving the filler material from the lower chamber to the upper chamber through the replenishment passage interconnecting the two chambers, such that the device does not require an inversion method of replenishing of a conventional hourglass timer.

In some embodiments, the interconnected upper chamber, depletion passage, and lower chamber form the shape of an hourglass, although any suitable shapes may be used. In some embodiments, the depletion passage is narrower in diameter than the upper and lower chambers.

In some embodiments, the replenishment passage is configured as a tubular column. In some embodiments, the replenishment passage is located inside the depletion passage. The replenishment passage may be configured to be obscured from sight by the filler material, or may be configured to be visible through the filler material. In some embodiments, the replenishment passage is located outside of the depletion passage. In some embodiments, the replenishment passage is configured as a pillar connecting the top and bottom portions of the hourglass device. In additional embodiments, two or more replenishment passages may be used to move the filler material from the lower chamber to the upper chamber. In some embodiments, the replenishment passage is made of transparent material. In some embodiments, the replenishment passage is coated in filler material so as to visibly appear as a column of filler material.

The present invention may be used with any suitable filler material. In some embodiments, the filler material comprises a granular material. In some embodiments, the filler material is sand. In some embodiments, the filler material is a liquid. In some embodiments, the filler material is gelatinous. In some embodiments, a combination of different filler materials may be used. The filler material may include one or more decorative elements, and may include elements of different colors, shapes, and sizes.

In some embodiments, the component for moving the filler material from the lower chamber to the upper chamber through the replenishment passage interconnecting the two chambers comprises an electric motor of conventional design. In some embodiments, the electric motor drives an auger located within the replenishment passage. The rotation of the auger moves the filler material upward from the lower chamber to the upper chamber, where it is re-deposited as a means of replenishing the supply of filler material in the upper chamber. In some embodiments, the electric motor drives a pump, the force of which moves the filler material upward from the lower chamber to the upper chamber. In some embodiments, the electric motor drives a mechanism (e.g., belt) for moving containers such as buckets, which are used to move the filler material upward from the lower chamber to the upper chamber, dumping their content upon reaching the upper chamber. The re-deposited filler material then flows via gravity from the upper chamber through the depletion passage to the lower chamber, where the replenishment cycle is repeated. The electric motor may be powered by any suitable means, such as via connection to a power source such as a battery or wall outlet.

In some embodiments, the replenishment cycle is continuous. In some embodiments, the replenishment cycle continues for a predetermined length of time. In some embodiments, the replenishment cycle is controlled by an electronic or mechanical timer of conventional design. In some embodiments, the timer is programmed by a user of the device. In some embodiments, the timer includes a control component and a mechanism and interface for setting and displaying elapsed and remaining time, such as a digital or analog display panel. In some embodiments, the timer includes a component for signaling an event, such as an audible or visual alarm.

The hourglass timer of the present invention may include a component for obscuring the replenishment mechanism. In some embodiments, the replenishment passage is configured to be obscured from sight by the filler material. In some embodiments, the external surface of the replenishment passage is covered with a material similar to the filler material in order to obscure it from view. In some embodiments, the replenishment passage is configured to retract into the lower chamber or the base of the device upon the ending of a replenishment cycle (i.e., when it is no longer hidden by filler material in the upper chamber and depletion passage).

Any ornamental design style may be used with the hourglass timer. For example, a traditional, contemporary, ancient, modern, futuristic, or any other design theme may be used.

The present invention is useful with an hourglass timer of any size. In some embodiments, the hourglass timer is miniature. In some embodiments, the hourglass timer is palm-sized. In some embodiments, the hourglass timer is sized to fit on a desktop. In some embodiments, the hourglass timer is sized to fit on a table top. In some embodiments, the hourglass timer is sized to be floor-standing. In some embodiments, the hourglass timer is giant-size. In some embodiments, the hourglass timer is sized to be easily viewable from a distance.

### DESCRIPTION OF THE FIGURE

FIG. 1 shows a front perspective view of an embodiment of the invention.

### DETAILED DESCRIPTION OF THE INVENTION

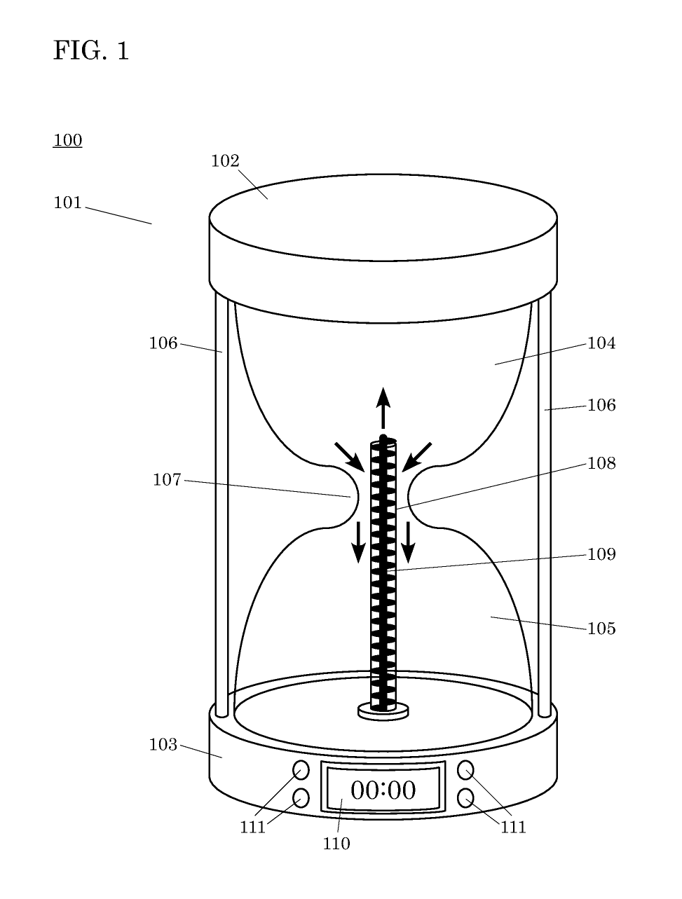

FIG. 1 shows an hourglass timer in one embodiment of the present invention. The depicted hourglass timer is of traditional design, although other design themes (e.g., contemporary, ancient, modern, futuristic, etc.) may be used. The hourglass timer 100 has a housing 101, a top portion 102, a base portion 103, a hollow upper chamber 104, a hollow lower chamber 105, and support pillars 106. The upper chamber 104 and lower chamber 105 are connected by a depletion passage 107. The depletion passage 107 is narrower in diameter than the upper chamber 104 and lower chamber 105, which serves as a means of restricting the flow of filler material from the upper chamber 104 to the lower chamber 105.

A replenishment passage 108 extends from the base portion 103 through the lower chamber 105 and the depletion passage 107 to the upper chamber 104. An auger 109 extends through the replenishment passage 108. The auger 109 is rotationally driven by an electric motor located within the base portion 103. The rotation of the auger 109 moves filler material from the lower chamber 105 upward through the replenishment passage 108 to the upper chamber 104, where it is re-deposited as a means of replenishing the supply of filler material in the upper chamber 104. The replenishment passage is configured to prevent filler material from entering the base portion 103 or coming into contact with the electric motor (e.g., with one or more seals).

The base portion 103 contains an electric motor of conventional design, a component for powering the electric motor, a mechanism for rotationally driving the auger 109 (e.g., a gear system, drive belts, etc.), and one or more components for controlling the functions of the device (e.g., a microprocessor and/or memory components). The electric motor can be powered by any conventional means, such as one or more batteries, a corded power supply for connection to an electrical outlet, one or more photovoltaic panels, etc.

The exterior surface of the base portion 103 houses a display panel 110 (e.g., a liquid crystal display (LCD) or light-emitting diode (LED) display) and one or more buttons 111 for controlling the functions of the hourglass timer device. Such functions include a programmable replenishment cycle. For example, the device can be programmed to continuously replenish the filler material in the upper chamber 104, or to replenish the filler material a specified number of times, or to replenish the filler material for a specified length of time. The device can be programmed to function as a timer, a clock, or an audible and/or visual alarm clock.

From the above description of the invention, those skilled in the art will perceive improvements, changes, and modifications. Such improvements, changes, and modifications within the skill of the art are intended to be covered by the appended claims.

We claim:

1. An hourglass device comprising a replenishment passage configured to recycle filler material deposited in a lower chamber to an upper chamber.

2. The device of claim 1, wherein the recycling is continuous.

3. The device of claim 1, wherein the recycling is for a preset time.

4. The device of claim 3, wherein the preset time is controlled by a user.

5. A method of keeping time comprising using the hourglass device of claim 1.
